(19) United States
(12) Patent Application Publication
(10) Pub. No.: US 2011/0025266 A1
(43) Pub. Date: Feb. 3, 2011

(54) CHARGING STRUCTURE OF UNSHELTERED ELECTRIC VEHICLE

(75) Inventors: Chi Chun LI, Taipei County (TW); Yung Han, Taipei County (TW)

Correspondence Address: RABIN & Berdo, PC, 1101 14TH STREET, NW, SUITE 500, WASHINGTON, DC, 20005, US

(73) Assignee: HERO BEAR ANIMATION CO., LTD., Taipei County (TW)

(21) Appl. No.: 12/844,998

(22) Filed: Jul. 28, 2010

(30) Foreign Application Priority Data
Aug. 3, 2009 (TW) 098214318

(51) Int. Cl. H02J 7/00

(52) U.S. Cl. 320/109

(57) ABSTRACT

A charging structure of an unsheltered electric vehicle has a vehicle with at least a frame, a handling unit and a power unit. The power unit has an output terminal which is one side connected with a mobile and rotary cover by a holding strip to have a water-tight protection, an adapting unit which connects the power unit via the output terminal, and an insertion part which is a movable connection with the output terminal. A rotary cover provides a rotatable connection and a water-tight protection for both combinations of the insertion part and above-mentioned output terminal, a power cord which is electrically connected with the insertion part, and at least a connector electrically connected with the other end of the power cord.

### FIELD OF THE INVENTION

This invention relates a charging structure of unsheltered electric vehicle specifically relating to a charging structure that can achieve the multi functions such as waterproofing, dust-proofing and stable configuration to enhance the practical usage during charging process.

### DESCRIPTION OF PRIOR ART

Due to the global trend of environmental protection, energy saving and carbon reduction, the prior electrically driven vehicle (for instance, electrically driven bicycle and electrically driven motorcycle, etc.) then gradually catches the attention around the world. However, prior electrically driven vehicle usually adopts rechargeable battery as the power source to empower the motor of the electrically driven vehicle for the riding purpose.

Since electrical energy had been adopted as a power source for environment protection purpose, electrically driven vehicles are thus installed with power output terminal for charging the portable electric devices. However, the power output terminals are designed as a simple structure lack of structural and safety protection. It might lead to a serious damage to the rechargeable battery by the accumulation of dust and moisture exposed in an opened environment. Furthermore, certain short circuit, current leakage or even worse danger to the body probably happens during a long distance ride. Apparently, there must be some improvement toward those prior charging structure onboard those electrically driven vehicles.

### SUMMARY OF THE INVENTION

This invention relates to a charging structure of unsheltered electric vehicle, which comprising a vehicle that contains at least a frame, a handling unit and a power unit, wherein the power unit is installed with an output terminal which is one side connected with a mobile and rotary cover by a holding strip to have a water-tight protection; an adapting unit which connects the power unit via the output terminal, and further contains an insertion part which is movable connection with the output terminal, a rotary cover which provides a rotatable connection and a waterproof protection for the combination of insertion part and above-mentioned output terminal, a power cord which is electrically connected with the insertion part, and at least an connector electrically connected with the other end of the power cord.

Therefore, the main objective of the present invention lies in both waterproof protection for the output terminal of the power unit by a rotatable cover during non-charging period, and for the inter-combination between the insertion part wrapped by the rotary cover of the adapting unit and the output terminal of the power unit during the charging process to provide a rechargeable power fed into the portable electric devices free from any damage could arise from moisture, dust and/or even dangerous hardware configuration.

Another objective of the present invention is to provide the rider living in high latitude or cold weather area a more comfortable and safer handling unit by resistors with heating function configured within both sides frame of the hand covers. Eventually, the present invention can also achieve a practical and rider-friendly structure for the unsheltered electric vehicle riders.

### BRIEF DESCRIPTION OF THE DRAWINGS

FIG. 1 illustrates a three-dimensional appearance of the first embodiment of the present invention.

FIG. 2 illustrates the practical application of the first embodiment of the present invention.

FIG. 3 illustrates the practical application of the second embodiment of the present invention.

FIG. 4 illustrates a three-dimensional appearance of the third embodiment of the present invention.

### DESCRIPTIONS OF THE MAJOR COMPONENTS

| | | | |
|---|---|---|---|
| 1 | Vehicle | 2 | Cover |
| 3 | Adapting unit | 4 | Portable electric device |
| 11 | Frame | 12 | Handling unit |
| 15 | Power unit | 16 | Heater |
| 21 | Holding strip | 31 | Insertion part |
| 32 | Connector | 33 | Insertion hole |
| 121 | Hand cover | 151 | Output terminal |
| 161 | Resistor | 162 | Plug |
| 163 | Switch | 311 | Rotary cover |
| 312 | Power cord | 321 | Adapter |

### DETAILED DESCRIPTION OF THE INVENTION

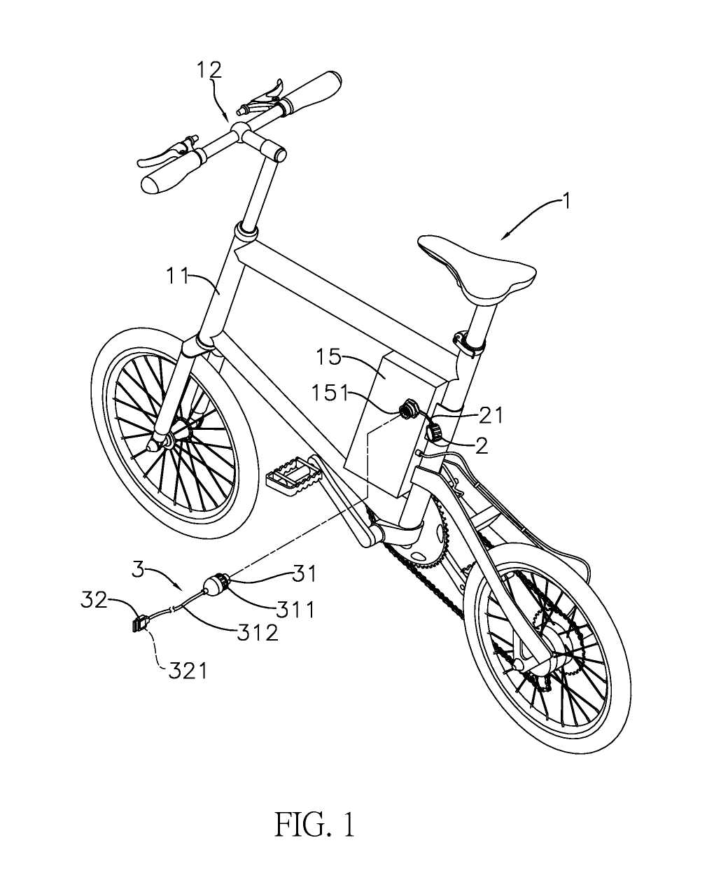

Please refer to the “FIG. 1”, which illustrates a three-dimensional appearance of the first embodiment of the present invention. As shown in the figure, this invention is a charging structure of unsheltered electric vehicle, which comprises a vehicle 1, a cover 2 and an adapting unit 3.

The said vehicle 1 further comprises at least a frame 11, a handling unit 12 that is movably installed aboard the frame 11 of the vehicle 1, and a power unit 15, configured with an output terminal 151, is installed aboard the frame 11 of the vehicle 1 to provide the power for the unsheltered electric vehicle.

The said output terminal 151 is one side connected with a mobile and rotatable cover 2 by a holding strip 21 to have a water-tight protection by screwing tight the cover 2 when the power unit 15 is not under charging.

The adapting unit 3, connecting the power unit 15 via the output terminal 151 during the charging process, further contains an insertion part 31 which is movable connection with the output terminal 151 for charging, a rotary cover 311 which provides a rotatable connection and a waterproof and dustproof protection for the combination of insertion part 31 and the said output terminal 151, a power cord 312 which is electrically connected with the insertion part 31, and at least an electric connector 32, with an adapter 321 configured inside, electrically connected with the other end of the power cord 312. Thus, it provides a charging structure of unsheltered electric vehicle.

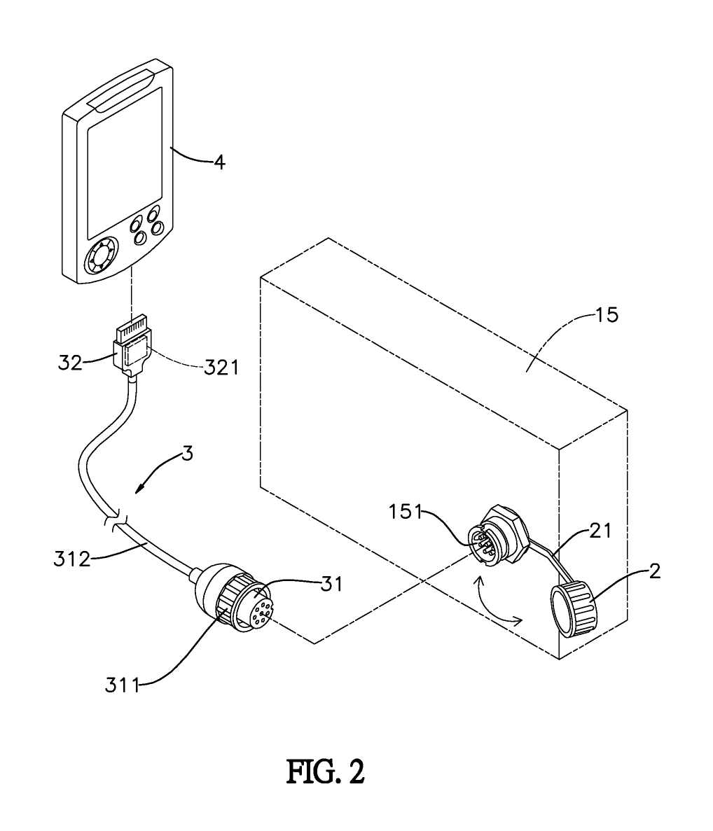

Please refer to the “FIG. 2”, which illustrates the practical application of the first embodiment of the present invention. As shown in this figure, before charging, the cover 2 is screwed off first and hanged besides the output terminal 151 by a holding strip 21. The electric connector 32, with an adapter 32 installed inside, fits into the power-in socket (not shown) of the external portable electric device 4. The insertion part 31 is then plugged into the output terminal 151 by an identified structure showing the direction of insertion to protect those pins of the output terminal 151. After that, the rotary cover 311 is rotated tight to offer waterproof, dustproof and stable protection for the combination of insertion part 31 and the output terminal 151 of the power unit 5. The charging power starts to be exported through the operation of adapter 32 installed inside the electric connector 32 of the power cord 312 to feed in the power needed for the portable electric device 4.

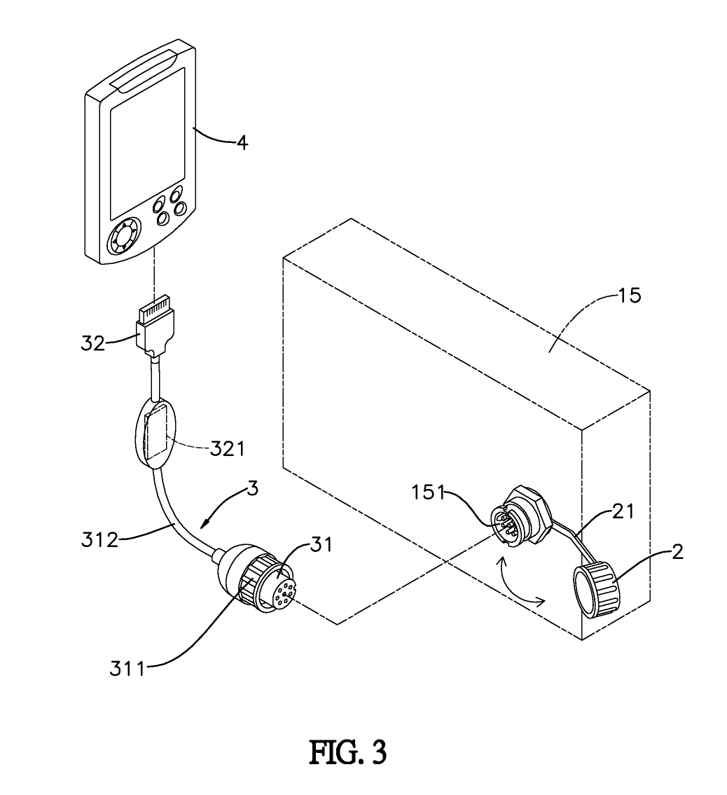

Please refer to the “FIG. 3”, which illustrates the practical application of the second embodiment of the present invention. As shown in this figure, the adapter 321 is configured at certain part of the power cord 312 (outside of the connector 312) to reserve more compatibility for the connection of the electric connector 32 and to provide an alternative solution for future development. Different electric portable device 4 might fit specified connector 32. However, those different electric connectors 32 could be configured as a changeable type at the other end of the adapting unit 3 and the power specification could be automatically adjusted by the output of the adapter 321. Thus, it enriches the function and practical application to material saving for variety of adapting units 3.

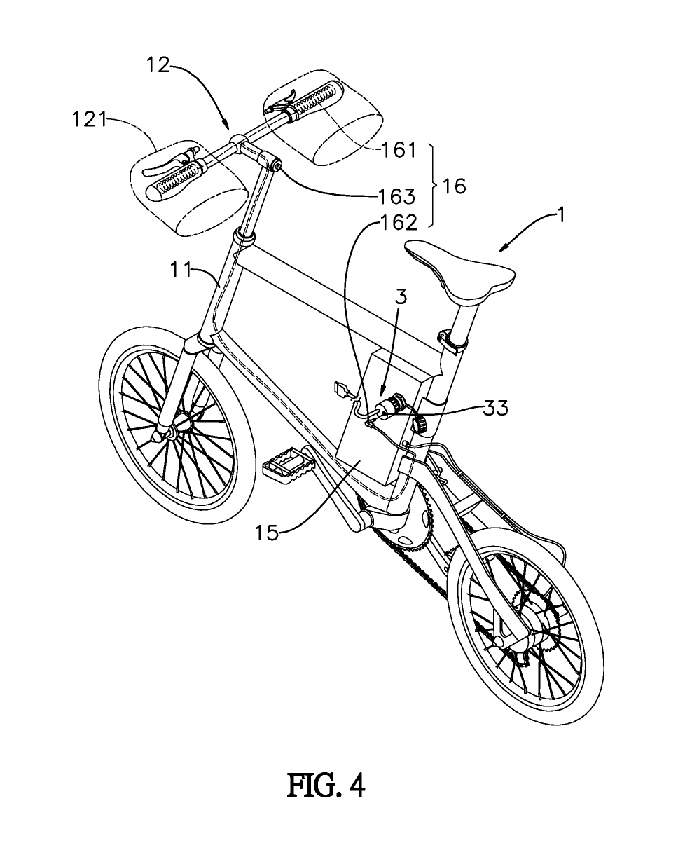

Please also refer to the “FIG. 4”, which illustrates a three-dimensional appearance of the third embodiment of the present invention. As shown in this figure, besides the said embodiments, the power output from the power unit 15 can provide a heater 16 function and can protect the hands for the vehicle riders in high latitude or cold weather area. The heater 16 comprises a plug 162, a switch 163 and both resistors 161. That is, the output power can be extended, through the plug 162 connected with the insertion hole 33 at one end of the adapting unit 3 which is connected with the output terminal 151 of the power unit 15, to the resistors 161 configured inside the handling unit 12 equipped with hand covers 121 at both sides to generate heat by controlling the switch 163 and to offer a more comfortable and safer vehicle handling structure.

To sum up, a charging structure of unsheltered electric vehicle of the present invention can effectively improve the charging function of the prior art applied in electricity driven vehicle. However, the above mentioned description are only some better embodiments of the present invention which shall not be used to limit the scope of the present invention and any equivalent change or revision based on the current invention should all be included in this invention.

What is claimed is:

1. A charging structure of unsheltered electric vehicle, comprising
a vehicle, which comprises a frame, a handling unit that is movably installed aboard the said frame, and a power unit that is configured with an output terminal and is installed aboard the said frame;
a cover, which is in a rotatable manner to be one side connected with the said output terminal by a holding strip; and
an adapting unit containing an insertion part, a rotary cover, a power cord and at least a connector that works with an adapter and electrically connected to the other end of the power cord.

2. A charging structure of unsheltered electric vehicle according to claim 1, the adapting unit is configured with an insertion hole at one end of the power cord.

3. A charging structure of unsheltered electric vehicle according to claim 1, wherein both sides of the handling unit of the vehicle are installed respectively with a hand cover, and the handling unit is further installed with an heater which could be electrically connected with the power unit and is comprises a plug which is connected with the insertion hole of the adapting unit, a switch and both resistors configured inside the handling unit.

4. A charging structure of unsheltered electric vehicle according to claim 1, wherein the adapter is configured within the connector of the adapting unit.

5. A charging structure of unsheltered electric vehicle according to claim 1, wherein the adapter is configured outside the connector and is located at certain part along the power cord of the adapting unit.
